(19) United States
(12) Patent Application Publication
(10) Pub. No.: US 2010/0191446 A1
(43) Pub. Date: Jul. 29, 2010

(54) SYSTEMS AND METHODS FOR PREDICTIVE ENGINE RE-STARTING AND PREDICTIVE NEUTRAL/IDLE OPERATION OF A VEHICLE

(75) Inventors: MIKE M. MC DONALD, MACOMB, MI (US); WILLIAM C. ALBERTSON, CLINTON TOWNSHIP, MI (US); JOSEPH F. NAZIONE, JR., MACOMB, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/361,127

(22) Filed: Jan. 28, 2009

(51) Int. Cl. F02N 11/08; G06F 17/00

(52) U.S. Cl. 701/113

(57) ABSTRACT

A predictive engine restart method and related systems for a host vehicle having an internal combustion engine are provided. An exemplary method begins by establishing a real-time data communication channel with a neighbor vehicle that is positioned in front of the host vehicle. The method continues by receiving vehicle status data from the neighbor vehicle using the real-time data communication channel. The vehicle status data includes transmission status data for the neighbor vehicle, accelerator pedal status data for the neighbor vehicle, and brake pedal status data for the neighbor vehicle. Then, the method re-starts the engine when the transmission status data indicates a mode other than park or neutral, and when the accelerator pedal status data indicates accelerator pedal travel greater than a threshold amount. Alternatively, the engine is re-started when the automatic transmission status data indicates a mode other than park or neutral, and when the brake pedal status data indicates a released condition.

### TECHNICAL FIELD

Embodiments of the subject matter described herein relate generally to vehicle control systems. More particularly, embodiments of the subject matter relate to predictive control systems that manage engine re-starting and neutral/idle operations for a vehicle.

### BACKGROUND

There is an ongoing need to improve fuel economy, reduce consumption of fuel, and reduce emissions in modern vehicles. Many hybrid vehicles utilize an engine start/stop feature that automatically shuts down the internal combustion engine when the vehicle is stopped. The engine is automatically restarted when the driver commands the vehicle to accelerate. Such engine restarting can be successfully implemented in hybrid vehicles because the electric motor is used to provide torque from a standstill. Accordingly, the driver does not experience any delay or “torque bump” that might otherwise be associated with engine restarting.

Due to the delayed response times associated with automatic engine restarting, that feature is not widely utilized in conventional vehicles that are driven by an internal combustion engine only. Thus, although the operator desires immediate responsiveness from the vehicle, vehicle launch may require that the engine be cranked and started prior to providing tractive torque to the vehicle wheels. Indeed, it may take up to a few seconds to crank and start an engine from a standstill, and such a delay is rarely (if ever) tolerable.

Accordingly, there is a need for an engine start/stop system for a vehicle powertrain which improves responsiveness, especially upon restarting of the engine. Similarly, there is a need for a system that can anticipate a shift from neutral to drive in an automatic transmission vehicle that employs a neutral/idle mode during vehicle stops.

### BRIEF SUMMARY

An embodiment of a predictive engine restart method for a host vehicle having an internal combustion engine is provided. The method begins by establishing a real-time data communication channel with a neighbor vehicle that is positioned in front of the host vehicle. The method continues by receiving vehicle status data from the neighbor vehicle using the real-time data communication channel, the vehicle status data comprising transmission status data for the neighbor vehicle, accelerator pedal status data for the neighbor vehicle, and brake pedal status data for the neighbor vehicle. The method re-starts the engine when the transmission status data indicates a mode other than park or neutral, and when the accelerator pedal status data indicates accelerator pedal travel greater than a threshold amount. Alternatively, the method re-starts the engine when the transmission status data indicates a mode other than park or neutral, and when the brake pedal status data indicates a released condition.

Also provided is an embodiment of a predictive engine restart system for a host vehicle having an internal combustion engine. The system includes means for receiving real-time front vehicle status data from a neighbor vehicle that is located in front of the host vehicle, the real-time front vehicle status data comprising transmission status data for the neighbor vehicle, accelerator pedal status data for the neighbor vehicle, and brake pedal status data for the neighbor vehicle. The system also includes means for obtaining real-time host vehicle status data for the host vehicle, the real-time host vehicle status data comprising engine on/off status data for the host vehicle, and engine speed data for the host vehicle. In addition, the system has means for re-starting the engine when either: (1) the engine on/off status data indicates an engine off status, the engine speed data indicates engine speed less than a threshold speed, the transmission status data indicates a mode other than park or neutral, and the accelerator pedal status data indicates accelerator pedal travel greater than a threshold amount; or (2) the engine on/off status data indicates an engine off status, the engine speed data indicates engine speed less than a threshold speed, the transmission status data indicates a mode other than park or neutral, and the brake pedal status data indicates a released condition.

An embodiment of a predictive neutral/idle operating method for a host vehicle having an internal combustion engine and an automatic transmission is also provided. This method involves electronically switching the automatic transmission from a drive mode to a neutral idle mode when the host vehicle is stopped, receiving location and heading data for one or more neighboring vehicles proximate the host vehicle, using a wireless vehicle-to-vehicle data communication scheme, and receiving host vehicle location and heading data. The method analyzes the location and heading data for the one or more neighboring vehicles, and the host vehicle location and heading data, to designate a neighbor vehicle from the one or more neighboring vehicles, the neighbor vehicle being positioned immediately in front of the host vehicle. The method also establishes a real-time wireless data communication channel between the host vehicle and the neighbor vehicle, and receives, via the real-time wireless data communication channel, front vehicle status data from the neighbor vehicle, the front vehicle status data comprising transmission status data for the neighbor vehicle, accelerator pedal status data for the neighbor vehicle, and brake pedal status data for the neighbor vehicle. The method then electronically switches the automatic transmission from the neutral idle mode to the drive mode when either: (1) the transmission status data indicates a mode other than park or neutral, and the accelerator pedal status data indicates accelerator pedal travel greater than a threshold amount; or (2) the transmission status data indicates a mode other than park or neutral, and the brake pedal status data indicates a released condition.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram that illustrates a host vehicle and a number of neighboring vehicles close to the host vehicle;

FIG. 2 is a schematic representation of onboard components that can be utilized to perform predictive engine re-starting and/or predictive neutral/idle operations for a host vehicle;

FIG. 3 is a schematic representation of onboard elements of an embodiment of a vehicle control system that is suitable for use with predictive engine re-starting and/or predictive neutral/idle operations;

FIG. 4 is a flow chart that illustrates an exemplary predictive engine re-start process; and

FIG. 5 is a flow chart that illustrates an exemplary predictive neutral/idle operating process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

FIG. 1 is a diagram that illustrates a host vehicle 100 and a number of neighboring vehicles close to host vehicle 100. As described in more detail herein, host vehicle 100 includes onboard subsystems and control logic associated with an engine start/stop feature and/or onboard subsystems and control logic associated with a neutral idle automatic transmission feature. FIG. 1 depicts one neighbor vehicle that is located immediately in front of host vehicle 100 (referred to here as the front vehicle 102), and a plurality of additional neighboring vehicles 104 that are within proximity to host vehicle 100.

The environment depicted in FIG. 1 assumes that at least host vehicle 100 and front vehicle 102 are outfitted with respective onboard systems that support wireless data communication between the vehicles. Of course, one or more of the neighboring vehicles 104 may also include such onboard systems. In this regard, host vehicle 100 and front vehicle 102 are suitably configured to carry out vehicle-to-vehicle data communication in a real-time (or virtually real-time) manner. In exemplary embodiments, host vehicle 100 includes an onboard dedicated short range communication (DSRC) module. Similarly, front vehicle 102 includes its own DSRC module. A DSRC module as referred to herein may include a DSRC receiver, a DSRC transmitter, and/or a DSRC transceiver as needed to support the particular system application.

The DSRC module in host vehicle 100 may be associated with a short or medium wireless data communication range, for reasons explained below. Accordingly, FIG. 1 depicts a wireless data communication range 106 associated with host vehicle 100 as a shape having a relatively small area. FIG. 1 schematically depicts wireless data communication range 106 encompassing front vehicle 102 and three of the four neighboring vehicles 104, all with the same directional heading. Thus, the DSRC module in host vehicle 100 is within range of the DSRC modules in front vehicle 102 and the three closest neighboring vehicles 104 with the same directional heading. Notably, FIG. 1 depicts a state wherein a real-time data communication channel 108 has been established between host vehicle 100 and front vehicle 102, preferably using an appropriate DSRC protocol. Host vehicle 100 receives vehicle status data of front vehicle 102 in a real-time manner using data communication channel 108, processes the received vehicle status data, and controls an engine start/stop feature and/or an automatic transmission neutral idle feature in a manner that is influenced by the received vehicle status data. Such onboard processing of the front vehicle status data is described in more detail below.

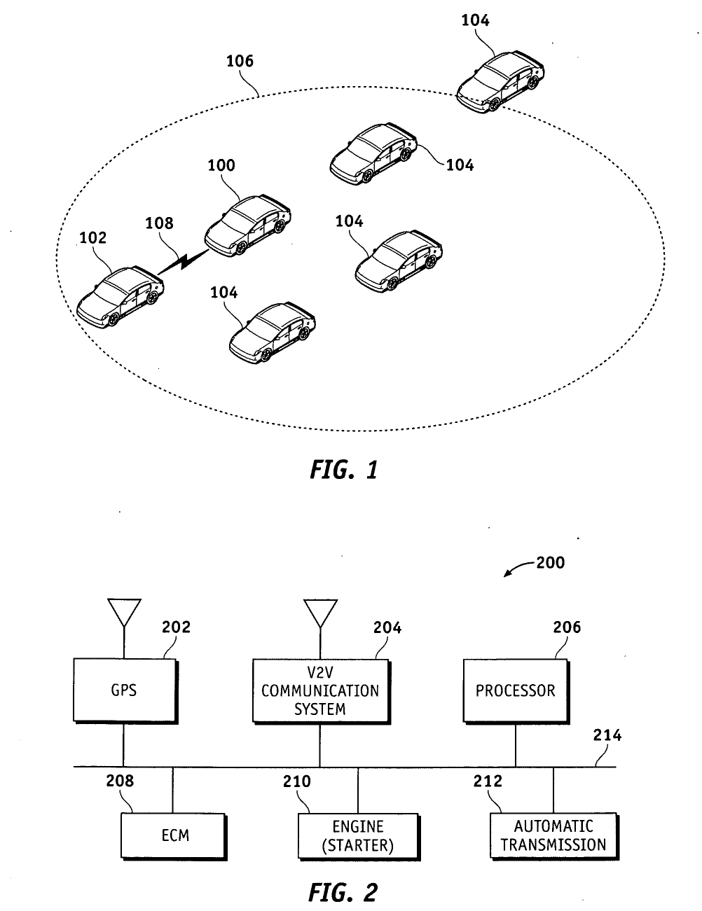

FIG. 2 is a schematic representation of onboard system 200 components that can be utilized to perform predictive engine re-starting and/or predictive neutral/idle operations for host vehicle 100. These onboard components may form a predictive engine restart system and/or a predictive neutral/drive transmission system for host vehicle 100. System 200 generally includes, without limitation: a locating or positioning system (such as a global positioning system 202); a vehicle-to-vehicle communication system 204; at least one processor 206; at least one electronic control module 208; an internal combustion engine 210 having a starter; and an automatic transmission 212. These components and elements may be coupled together using a bus or any appropriate interconnect architecture 214 that facilitates the communication of signals, commands, control instructions, and the like.

Although any suitably configured location or position data system can be used with system 200, preferred embodiments utilize global positioning system (GPS) 202. GPS 202 includes a GPS receiver and antenna that receives GPS data from GPS satellites. GPS 202 processes the received GPS data in a conventional manner to resolve the current location and heading of the host vehicle. In this regard, GPS 202 generates, obtains, or otherwise receives location and heading data of the host vehicle. As will be described in more detail below, GPS 202 may be used to designate the front vehicle (relative to the host vehicle) from a plurality of neighboring vehicles that are proximate the host vehicle. The importance of this location and heading data will be further explained below.

Vehicle-to-vehicle (V2V) communication system 204 represents the hardware, software, firmware, and/or processing logic associated with a suitably configured wireless data communication system that establishes a wireless data communication channel between the host vehicle and at least one other neighbor vehicle. As one example, V2V communication system 204 may be realized as a DSRC module as described above. V2V communication system 204 is preferably utilized to receive location and heading data of neighboring vehicles and to receive vehicle status data from neighboring vehicles, using a real-time data communication channel.

System 200 may utilize one or more processors 206, which may be co-located or distributed throughout the host vehicle. Thus, although only one processor block is shown in FIG. 2, a practical implementation may utilize any number of distinct physical and/or logical processors, which may be dispersed throughout the vehicle. A processor 206 may be incorporated or otherwise integrated with another module, device, or subsystem, e.g., electronic control module (ECM) 208 or another electronic control unit (ECU). Processor 206 is configured to perform, control, and/or regulate the start/stop and neutral/drive techniques described herein. In practice, processor 206 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

The steps of a method or algorithm described in connection with the embodiments disclosed herein may be embodied directly in hardware, in firmware, in a software module executed by processor 206 or ECM 208, or in any practical combination thereof. In this regard, a software module may reside in memory (not shown) or any other suitable storage medium. In practice, a memory element can be coupled to processor 206 such that processor 206 can read information from, and write information to, the memory. In the alternative, the memory may be integral to processor 206. As an example, processor 206 and memory may reside in an ASIC.

ECM 208 represents the control hardware, software, firmware, and/or logic that is responsible for controlling automated start/stop functions and automated neutral/drive functions for the host vehicle. Thus, ECM 208 is communicatively coupled to engine 210 (and/or the starter for engine 210) and to automatic transmission 212 in an appropriate manner. More particularly, ECM 208 and/or processor 206 can obtain real-time host vehicle status data for the host vehicle, and process that status data (along with front vehicle status data) to predict and determine when to restart the engine of the host vehicle or when to electronically and automatically switch the automatic transmission of the host vehicle from a neutral idle mode to a drive mode. Although not separately depicted in FIG. 2, system 200 preferably includes a suitably configured controller or control logic that is responsible for automatically stopping and starting engine 210, and a suitably configured controller or control logic that is responsible for automatically switching automatic transmission 212 between the neutral idle state and the drive state.

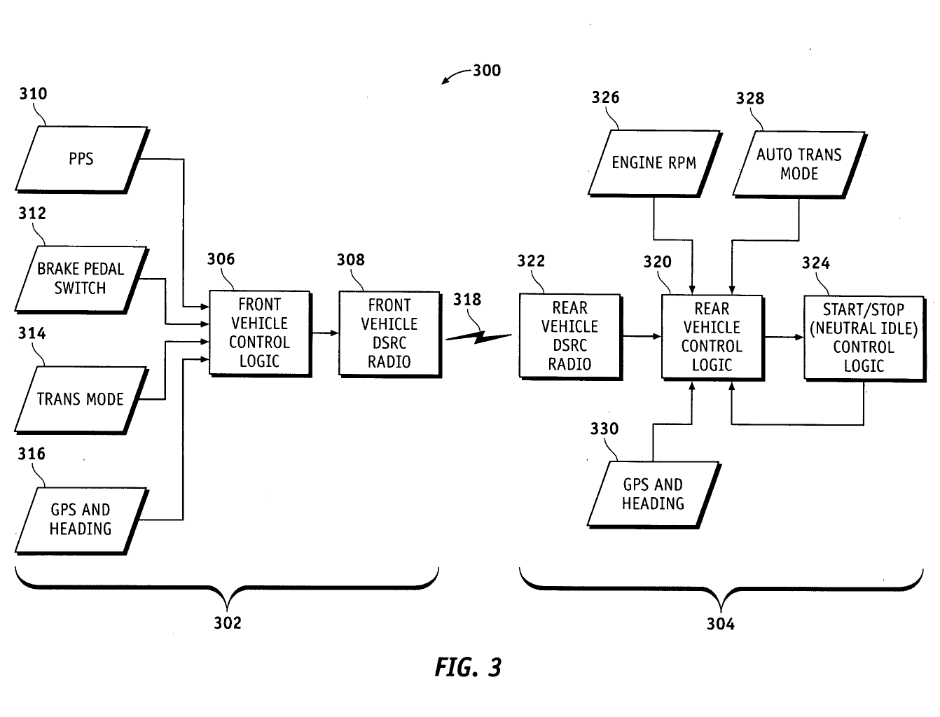

FIG. 3 is a schematic representation of onboard elements of an embodiment of a vehicle control system 300 that is suitable for use with predictive engine re-starting and/or predictive neutral/idle operations. FIG. 3 depicts elements, features, and data associated with a front vehicle 302, and elements, features, and data associated with a host vehicle 304. In this regard, system 200 (see FIG. 2) may be utilized in vehicle control system 300.

Front vehicle 302 includes front vehicle control logic 306 and a V2V communication module, such as a DSRC radio module 308. Front vehicle control logic 306 (which may be realized using any number of hardware, software, firmware, and/or processor elements) receives and processes a number of different data types that originate from a number of different data sources onboard front vehicle 302.

For this particular embodiment, front vehicle control logic 306 obtains accelerator pedal status data for front vehicle 302. This accelerator pedal status data is also referred to here as pedal position sensor (PPS) data 310. PPS data 310 is indicative of the position of the accelerator pedal, where the position ranges between zero percent actuation (i.e., the accelerator pedal is not depressed) and full actuation (i.e., the accelerator pedal is completely depressed). Front vehicle control logic 306 may also obtain brake pedal status data for front vehicle 302. This brake pedal status data may be indicative of the travel position of the brake pedal and/or it may simply indicate whether or not the brake pedal has been engaged. In this regard, preferred embodiments might leverage brake pedal switch data 312, which is also used to activate the brake lights of front vehicle 302. Front vehicle control logic 306 may also obtain transmission status data 314 for front vehicle 302. If front vehicle 302 has an automatic transmission, then transmission status data 314 will indicate whether front vehicle 302 is currently in a Park, Neutral, Reverse, or Drive mode. If front vehicle 302 has a manual transmission, then transmission status data 314 might indicate whether front vehicle 302 is currently in a Neutral, Reverse, or Drive mode. In certain embodiments, front vehicle control logic 306 also receives real-time location and heading data of front vehicle 302. In practice, the location and heading data may be provided in the form of GPS position and heading data 316. Such GPS position and heading data 316 can be generated by an appropriate onboard GPS, as described above with reference to system 200 (see FIG. 2).

Front vehicle control logic 306 can receive, process, analyze, calibrate, reformat and/or otherwise handle the various data in an appropriate manner. For example, front vehicle control logic 306 might receive raw PPS data 310, interpret it, and reformat it for communication to host vehicle 304. Front vehicle control logic 306 may also process its received data into a format that can be understood by the system onboard host vehicle 304.

Front vehicle control logic 306 passes information to front vehicle DSRC radio module 308, which then wirelessly transmits the front vehicle status data to host vehicle 304. In preferred embodiments, the front vehicle status data is transmitted to host vehicle 304 in real-time over a dedicated wireless link 318.

Host vehicle 304 includes, without limitation: host/rear vehicle control logic 320; a V2V communication module, such as a DSRC radio module 322; and control logic 324 associated with engine start/stop functionality. Alternatively or additionally, control logic 324 is associated with automatic transmission neutral/drive idle switching.

DSRC radio module 322 receives the data transmitted from front vehicle 302, via wireless link 318. In this regard, DSRC radio module 322 is compatible with DSRC radio module 308 of front vehicle 302. Host vehicle control logic 320 obtains the received front vehicle status data from DSRC radio module 322 and processes that data as needed. Host vehicle control logic 320 (which may be realized using any number of hardware, software, firmware, and/or processor elements) may also receive and process a number of different data types that originate from a number of different data sources onboard host vehicle 304.

For this particular embodiment, host vehicle control logic 320 obtains engine speed data for host vehicle 304. This engine speed data may indicate, for example, the engine RPM 326. Host vehicle control logic 320 may also obtain transmission status data 328 for host vehicle 304. This transmission status data 328 will indicate whether host vehicle 304 is currently in a Park, Neutral, Reverse, or Drive mode. Moreover, transmission status data 328 could also indicate whether host vehicle is currently in a neutral idle state. As explained above, a neutral idle mode can be utilized to conserve fuel and reduce emissions—the automatic transmission of host vehicle 304 is switched (without driver involvement) to a Neutral mode when host vehicle 304 is stopped. In certain embodiments, host vehicle control logic 320 also receives real-time location and heading data of host vehicle 304. In practice, the location and heading data may be provided in the form of GPS position and heading data 330, which may be provided by GPS 202 (see FIG. 2).

In preferred embodiments, control logic 324 governs the automated engine start/stop functionality for host vehicle 304. Alternatively or additionally, control logic 324 regulates the automated switching of transmission modes to support neutral idle functionality for host vehicle 304. FIG. 3 depicts control logic 324 receiving instructions, commands, or information from host vehicle control logic 320. In this regard, control logic 324 is responsive to host vehicle control logic 320, which determines when to start and stop the engine and/or when to switch between Drive and Neutral. The feedback path from control logic 324 to host vehicle control logic 320 may be used to convey status information related to the engine start/stop feature and/or the neutral idle feature. For example, host vehicle control logic 320 might use this feedback path to receive engine on/off status data for host vehicle 304.

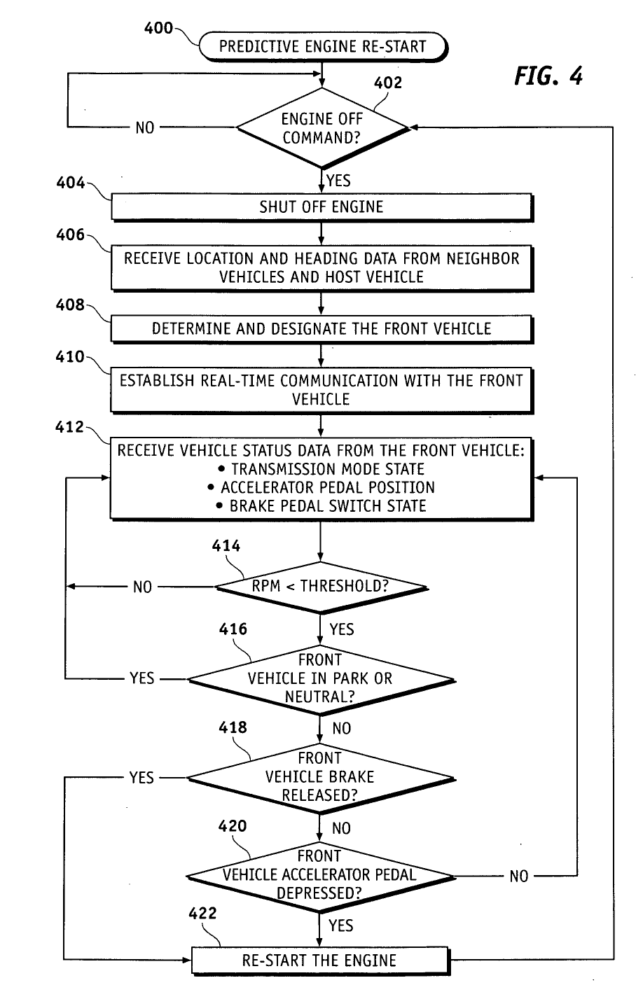

FIG. 4 is a flow chart that illustrates an exemplary predictive engine re-start process 400, which may be executed by a host vehicle. The various tasks performed in connection with process 400 may be performed by software, hardware, firmware, or any combination thereof. For illustrative purposes, the following description of process 400 may refer to elements mentioned above in connection with FIGS. 1-3. In practice, portions of process 400 may be performed by different elements of the described system, e.g., a wireless data communication module, an onboard sensor, a processor element, or an ECM. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein.

Process 400 is utilized with a host vehicle that is outfitted with an automatic engine start/stop feature, as explained above. This particular embodiment of process 400 checks whether an “engine off” command has been issued for the host vehicle (query task 402). An “engine off” command may be issued during operation of the host vehicle when the vehicle is at a standstill and has been idling for longer than a designated amount of time. If query task 402 detects an “engine off” command, then the host vehicle will shut off its internal combustion engine (task 404). Consequently, most of the following process steps are only performed when the host vehicle is stopped and/or when the engine speed of the host vehicle is less than a threshold speed (zero RPM). At this time, the host vehicle polls neighboring vehicles that are within proximity, and receives respective location and heading data for the neighboring vehicles (task 406). In preferred embodiments, the location and heading data of the neighboring vehicles is received using a short or medium range wireless V2V data communication scheme, e.g., a DSRC protocol. During task 406, process 400 may also receive or obtain location and heading data for the host vehicle itself.

The location and heading data for the host vehicle and the neighboring vehicles can then be analyzed or otherwise processed to determine and designate one of the neighboring vehicles as the front vehicle, which is positioned immediately in front of the host vehicle (task 408). Task 408 may leverage known GPS locating or positioning techniques and methodologies, such as triangulation, to determine the absolute or relative positions of the neighboring vehicles and the host vehicle. In this manner, task 408 can identify which one of the neighboring vehicles is the “front vehicle” for purposes of subsequent processing. Certain embodiments may utilize a distance threshold, such as ten meters, for purposes of designating the front vehicle. If such a threshold is used, a neighboring vehicle can be designated the “front vehicle” only if it is less than ten meters away from the host vehicle. In such embodiments, if no neighboring vehicle is less than ten meters in front of the host vehicle, then process 400 can exit to allow the host vehicle to perform conventional engine start/stop procedures.

After the front vehicle has been designated, process 400 can establish a real-time data communication channel with the front vehicle (task 410). In preferred embodiments, task 410 establishes a dedicated wireless V2V channel between the front vehicle and the host vehicle. Exemplary embodiments utilize DSRC, and the following description will refer to a DSRC channel, DSRC communication protocols, and DSRC technology.

The host vehicle uses the DSRC channel to receive real-time vehicle status data from the front vehicle (task 412). Although the vehicle status data may vary from one implementation to another, this embodiment receives at least the following vehicle status data from the front vehicle: transmission status data; accelerator pedal status data; and brake pedal status or switch data. The host vehicle control logic then proceeds to analyze the front vehicle status data (along with vehicle status data of the host vehicle as needed) to determine how best to control the engine start/stop subsystem of the host vehicle.

In certain embodiments, process 400 will check whether the engine is still shut down (due to the start/stop operation) and whether the current engine speed is less than a stated threshold speed (query task 414). If the engine happens to be on or if the engine speed is above the threshold speed (e.g., above zero RPM), then process 400 may exit or be re-entered at an appropriate location, such as task 412. This check is desirable to ensure that the host vehicle does not attempt to restart the engine while it is still rotating, such as immediately after the engine is commanded to be shut down. If query task 414 determines that the engine is off, then process 400 continues as described below.

The transmission status data of the front vehicle can be analyzed to determine whether the front vehicle is currently in Park or Neutral (query task 416). If so, then process 400 may exit or be re-entered at an appropriate location, such as task 412. This result is based on the assumption that the front vehicle will not be moving in the immediate future if its transmission is still in Neutral or Park. Consequently, if the transmission status data indicates a mode other than Park or Neutral, then process 400 can proceed to check the brake status data and/or the accelerator pedal status data.

If the brake status data indicates a released condition for the front vehicle brakes (query task 418), in other words, the brake pedal of the front vehicle is not actuated, then the engine of the host vehicle is re-started in an automated manner and without driver involvement (task 422). This result is based on the assumption that the driver of the front vehicle will be moving the front vehicle in the very near future. Alternatively, task 422 can be performed if the accelerator pedal status data indicates accelerator pedal travel greater than a threshold amount (query task 420). This condition occurs, for example, when the driver of the front vehicle has depressed the accelerator pedal by some amount. Of course, when the accelerator pedal of the front vehicle is activated, the front vehicle will soon move forward or backward. Notably, even if the transmission of the front vehicle is in Drive or Reverse, the engine of the host vehicle will remain shut down until process 400 detects release of the front vehicle brake pedal or activation of the front vehicle accelerator pedal. If neither of these conditions is detected, then process may exit or be re-entered at an appropriate location, such as task 412.

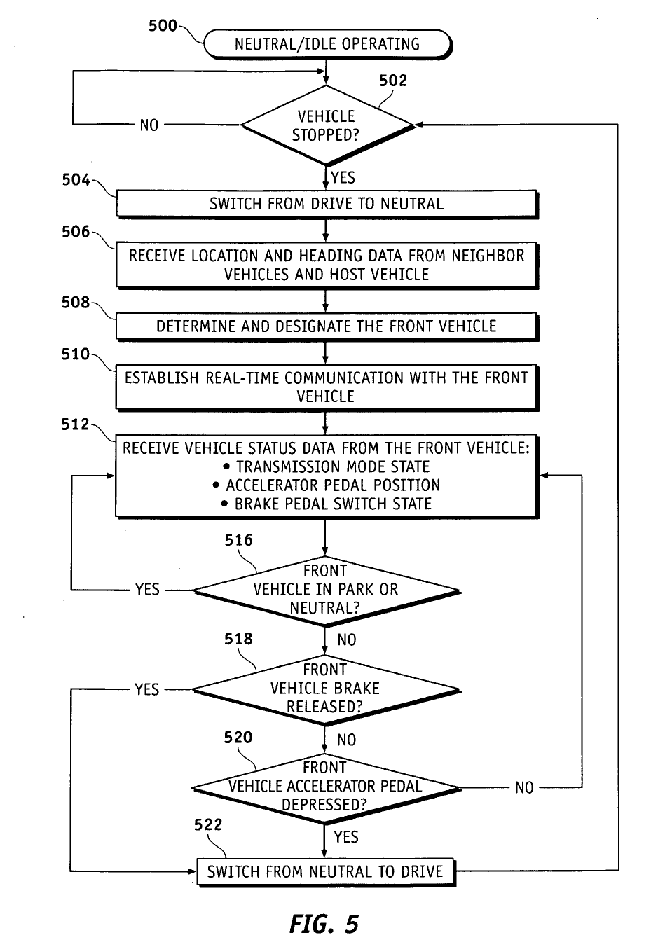

FIG. 5 is a flow chart that illustrates an exemplary predictive neutral/idle operating process 500, which may be executed by a host vehicle. The various tasks performed in connection with process 500 may be performed by software, hardware, firmware, or any combination thereof. For illustrative purposes, the following description of process 500 may refer to elements mentioned above in connection with FIGS. 1-4. In practice, portions of process 500 may be performed by different elements of the described system, e.g., a wireless data communication module, an onboard sensor, a processor element, or an ECM. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. Moreover, a number of tasks performed by process 500 are similar, identical, or equivalent to counterpart tasks performed by process 400 (see FIG. 4). For the sake of brevity and simplicity, common tasks, features, and operations will not be redundantly described here in the context of process 500.

Process 500 is utilized with a host vehicle that is outfitted with an automatic transmission that can be electronically controlled to transition between neutral idle and drive modes, as explained above. This particular embodiment of process 500 checks whether the host vehicle has been stopped for an amount of time (while still in Drive), such that a neutral idle command is issued (query task 502). If query task 502 detects a “neutral idle” command, then the host vehicle will electronically switch its automatic transmission from a Drive mode to a Neutral Idle mode (task 504). At this time, the host vehicle polls neighboring vehicles, receives location and heading data (task 506), designates the front vehicle (task 508), establishes real-time communication with the front vehicle (task 510), and receives front vehicle status data (task 512). These tasks were described above in the context of process 400 (see FIG. 4).

Process 500 can perform appropriate checks, comparisons, and decisions to determine whether or not to switch the automatic transmission of the host vehicle from the Neutral Idle mode to the Drive mode. In this regard, process 500 can check the transmission status data of the front vehicle (query task 516), check the brake status data of the front vehicle (query task 518), and check the accelerator pedal status data of the front vehicle (query task 520). These tasks were described above in the context of process 400 (see FIG. 4).

Under certain conditions, process 500 electronically switches the automatic transmission of the host vehicle from the Neutral Idle mode to the Drive mode in an automated manner and without driver involvement (task 522). For example, task 522 can be performed when the automatic transmission status data of the front vehicle indicates a mode other than Park or Neutral, and the accelerator pedal status data of the front vehicle indicates accelerator pedal travel greater than a threshold amount. Alternatively, task 522 can be performed when the automatic transmission status data of the front vehicle indicates a mode other than Park or Neutral, and the brake pedal status data of the front vehicle indicates a released condition. Notably, these two conditions are the same conditions described above with reference to process 400 (see FIG. 4).

The techniques and methodologies described herein can be implemented to increase customer satisfaction with fuel saving start/stop or neutral idle features of their vehicles. The systems described above leverage GPS and DSRC technologies to anticipate a driver's request for torque, then command a restart from the start/stop control system (or a switch from Neutral Idle to Drive) to prepare the powertrain for delivery of drive torque. These techniques can result in increased fuel economy without customer dissatisfaction associated with time delays inherent with start/stop and neutral idle powertrains.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A predictive engine restart method for a host vehicle having an internal combustion engine, the method comprising:
establishing a real-time data communication channel with a neighbor vehicle that is positioned in front of the host vehicle;
receiving vehicle status data from the neighbor vehicle using the real-time data communication channel, the vehicle status data comprising transmission status data for the neighbor vehicle, accelerator pedal status data for the neighbor vehicle, and brake pedal status data for the neighbor vehicle;
re-starting the engine when the transmission status data indicates a mode other than park or neutral, and when the accelerator pedal status data indicates accelerator pedal travel greater than a threshold amount; and
re-starting the engine when the automatic transmission status data indicates a mode other than park or neutral, and when the brake pedal status data indicates a released condition.

2. The method of claim 1, further comprising the step of designating the neighbor vehicle from a plurality of neighboring vehicles proximate the host vehicle.

3. The method of claim 2, wherein the designating step comprises the step of analyzing real-time location and heading data of the host vehicle and the neighboring vehicles.

4. The method of claim 3, further comprising receiving the location and heading data of the neighboring vehicles using a dedicated short range communication protocol.

5. The method of claim 1, wherein the establishing step establishes the real-time data communication channel using a dedicated short range communication protocol.

6. The method of claim 1, wherein the establishing step is performed only when the host vehicle is stopped.

7. The method of claim 1, wherein the establishing step is performed only when engine speed of the host vehicle is less than a threshold speed.

8. A predictive engine restart system for a host vehicle having an internal combustion engine, the system comprising:
means for receiving real-time front vehicle status data from a neighbor vehicle that is located in front of the host vehicle, the real-time front vehicle status data comprising transmission status data for the neighbor vehicle, accelerator pedal status data for the neighbor vehicle, and brake pedal status data for the neighbor vehicle;
means for obtaining real-time host vehicle status data for the host vehicle, the real-time host vehicle status data comprising engine on/off status data for the host vehicle, and engine speed data for the host vehicle; and
means for re-starting the engine when either:
the engine on/off status data indicates an engine off status, the engine speed data indicates engine speed less than a threshold speed, the transmission status data indicates a mode other than neutral, and the accelerator pedal status data indicates accelerator pedal travel greater than a threshold amount; or
the engine on/off status data indicates an engine off status, the engine speed data indicates engine speed less than a threshold speed, the transmission status data indicates a mode other than neutral, and the brake pedal status data indicates a released condition.

9. The system of claim 8, further comprising means for designating the neighbor vehicle from a plurality of neighboring vehicles proximate the host vehicle.

10. The system of claim 9, wherein the means for designating analyzes real-time location and heading data of the host vehicle and the neighboring vehicles.

11. The system of claim 10, further comprising a dedicated short range communication receiver that receives the location and heading data of the neighboring vehicles using a dedicated short range communication protocol.

12. The system of claim 10, wherein the means for designating comprises a global positioning system (GPS) receiver that determines the location data of the host vehicle.

13. The system of claim 8, wherein the means for receiving comprises a dedicated short range communication receiver that receives the real-time front vehicle status data using a dedicated short range communication protocol.

14. The system of claim 8, wherein the means for re-starting comprises an electronic engine control module of the host vehicle.

15. The system of claim 8, wherein the means for receiving, the means for obtaining, and the means for re-starting are onboard the host vehicle.

16. A predictive neutral/idle operating method for a host vehicle having an internal combustion engine and an automatic transmission, the method comprising:
electronically switching the automatic transmission from a drive mode to a neutral idle mode when the host vehicle is stopped;
receiving location and heading data for one or more neighboring vehicles proximate the host vehicle, using a wireless vehicle-to-vehicle data communication scheme;
receiving host vehicle location and heading data;
analyzing the location and heading data for the one or more neighboring vehicles, and the host vehicle location and heading data, to designate a neighbor vehicle from the one or more neighboring vehicles, the neighbor vehicle being positioned immediately in front of the host vehicle;
establishing a real-time wireless data communication channel between the host vehicle and the neighbor vehicle;
receiving, via the real-time wireless data communication channel, front vehicle status data from the neighbor vehicle, the front vehicle status data comprising automatic transmission status data for the neighbor vehicle, accelerator pedal status data for the neighbor vehicle, and brake pedal status data for the neighbor vehicle; and
electronically switching the automatic transmission from the neutral idle mode to the drive mode when either:
the automatic transmission status data indicates a mode other than park or neutral, and the accelerator pedal status data indicates accelerator pedal travel greater than a threshold amount; or
the automatic transmission status data indicates a mode other than park or neutral, and the brake pedal status data indicates a released condition.

17. The method of claim 16, wherein the location and heading data for the one or more neighboring vehicles is received using a dedicated short range communication protocol.

18. The method of claim 16, wherein the establishing step establishes the real-time wireless data communication channel using a dedicated short range communication protocol.

19. The method of claim 16, wherein the location and heading data for the neighboring vehicles and the host vehicle location and heading data for the host vehicle comprises global positioning system (GPS) data.
